(19) United States
(12) Patent Application Publication
(10) Pub. No.: US 2020/0293081 A1
(43) Pub. Date: Sep. 17, 2020

(54) SYSTEMS AND METHODS FOR POWER CONSERVATION ON AN AUDIO BUS THROUGH CLOCK MANIPULATION

(71) Applicant: QUALCOMM Incorporated, San Diego, CA (US)

(72) Inventors: Lior Amarilio, Yokneam (IL); Ghanashyam Prabhu, Bangalore (IN); Sharon Graif, Zichron Yaakov (IL)

(21) Appl. No.: 16/353,426

(22) Filed: Mar. 14, 2019

(51) Int. Cl. G06F 1/08; G06F 13/24; H04B 1/20; H04L 7/00; G06F 11/07

(52) U.S. Cl. CPC G06F 1/08; G06F 13/24; G06F 11/0757; H04L 7/0037; H04B 1/207

(57) ABSTRACT

Systems and methods for power conservation on an audio bus through clock manipulation allow a clock signal on an audio bus such as a SOUNDWIRE audio bus to be stopped when there are no pending commands from a master device. The clock signal may resume when a new command from the master device is generated or the master device receives an interrupt from a slave device.

### BACKGROUND

### I. Field of the Disclosure

The technology of the disclosure relates generally to power conservation on an audio bus.

### II. Background

Mobile communication devices have become increasingly common in current society. The prevalence of these mobile communication devices is driven in part by the many functions that are now enabled on such devices, Increased processing capabilities in such devices mean that mobile communication devices have evolved from pure communication tools into sophisticated mobile entertainment centers, thus enabling enhanced user experiences.

The mobile communication devices commonly include at least one microphone and multiple speakers. The microphone and the speakers used in the mobile communication devices typically have analog interfaces which require a dedicated two-wire connection between each pair of devices. Since a mobile communication device is capable of supporting multiple audio devices, it may be desirable to allow a microprocessor or other control device in the mobile communication device to communicate audio data to multiple audio devices over a common communication bus simultaneously.

In this regard, the MIPI® Alliance initially developed the Serial Low-power Inter-chip Media Bus (SLIMbus℠ or SLIMBUS) to handle audio signals within a mobile communication device. The first release was published in October 2005 with v1.01 released on Dec. 3, 2008. In response to industry feedback, MIPI has also developed SoundWire℠ (SOUNDWIRE), a communication protocol for a processor in the mobile communication device (the “master”) to control distribution of digital audio streams between one or more audio devices (the “slave(s)”) via one or more SOUNDWIRE slave data ports. Version 1 was released on Jan. 21, 2015.

While SOUNDWIRE is well suited for use in mobile terminals, there are trade-offs associated with the use of SOUNDWIRE. For example, most mobile terminals are battery powered. Consumers demand that time between battery charging be maximized. Accordingly, there is pressure to reduce power consumption in mobile terminals. SOUNDWIRE, by design (in part to reduce latency), maintains an active clock and data line(s) at all times. Maintaining such an active clock and data line(s) does consume battery power. Accordingly, there may be room to improve battery power utilization by a SOUNDWIRE bus.

### SUMMARY OF THE DISCLOSURE

Aspects disclosed in the detailed description include systems and methods for power conservation on an audio bus through clock manipulation. In particular, exemplary aspects of the present disclosure provide for systems and methods for allowing a clock signal on an audio bus such as a SOUNDWIRE audio bus to be stopped when there are no pending commands from a master device. The clock signal may resume when a new command from the master device is generated or the master receives an interrupt from a slave device. By stopping the clock signal in this fashion, power is saved because the clock transitions on the bus are eliminated. Further, latency is held to a minimum by allowing the master to respond to interrupts from the slaves.

In this regard in one aspect, an apparatus is disclosed. The apparatus includes an audio bus master. The audio bus master includes a bus interface coupled to an audio bus. The bus interface includes a frame control circuit configured to enter a clock stop state when a command is not pending.

In another aspect, an apparatus is disclosed. The apparatus includes an audio bus master. The audio bus master includes a means to couple to an audio bus. The means to couple to the audio bus includes a means to enter a clock stop state when a command is not pending.

In another aspect, a method of controlling an audio bus is disclosed. The method includes determining that no command is pending for the audio bus. The method also includes entering a clock stop state responsive to determining that no command is pending.

### BRIEF DESCRIPTION OF THE FIGURES

FIG. 1A is a block diagram of an exemplary audio system incorporating a SOUNDWIRE audio bus;

FIG. 1B is a simplified block diagram of a master device from the audio system of FIG. 1A;

FIG. 2A is a simplified timeline showing conventional activity on a bus with continuous interrogation of slave devices by a master device;

FIG. 2B is a simplified timeline showing clock stop and suspension of interrogation according to an exemplary aspect of the present disclosure;

FIG. 3A is a flowchart illustrating an exemplary process for stopping the clock according to the present disclosure;

FIG. 3B is a flowchart illustrating an alternate exemplary process for checking to see if a slave is still attached after clock stoppage and before executing new commands;

FIG. 4 is a simplified block diagram of an exemplary logic circuit for providing clock suspension according to the present disclosure;

FIG. 5 is a simplified block diagram of an alternate exemplary logic circuit with a delay before provision of clock suspension according to the present disclosure; and

FIG. 6 is a block diagram of an exemplary mobile terminal that can include the audio system of FIG. 1A.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include systems and methods for power conservation on an audio bus through clock manipulation. In particular, exemplary aspects of the present disclosure provide for systems and methods for allowing a clock signal on an audio bus such as a SOUNDWIRE audio bus to be stopped when there are no pending commands from a master device. The clock signal may resume when a new command from the master device is generated or the master receives an interrupt from a slave device. By stopping the clock signal in this fashion, power is saved because the clock transitions on the bus are eliminated. Further, latency is held to a minimum by allowing the master to respond to interrupts from the slaves.

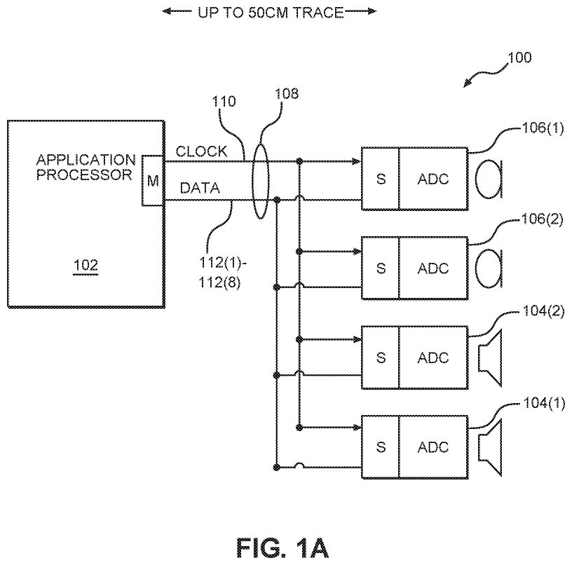

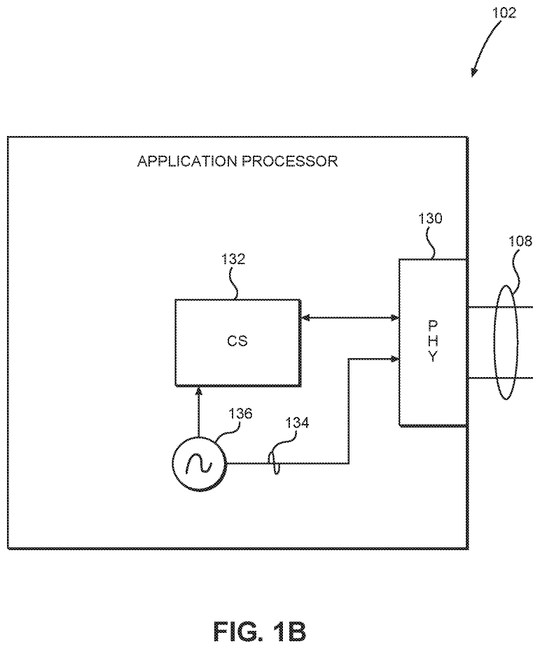

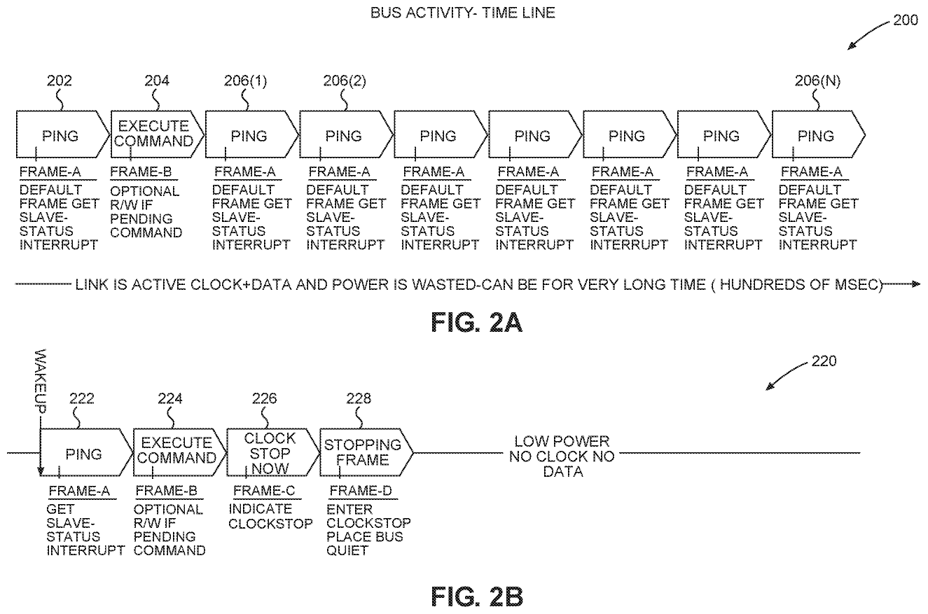

Before addressing particulars of the present disclosure, an overview of an audio system, and particularly a SOUNDWIRE audio system, are provided with reference to FIGS. 1A and 1B. An overview of how an audio bus may consume power is provided with reference to FIG. 2A, and exemplary aspects of the present disclosure are discussed below beginning with reference to FIG. 2B.

In this regard, FIG. 1A is block diagram of an exemplary SOUNDWIRE system 100. The SOUNDWIRE system 100 includes an application processor 102 coupled to a plurality of microphones 104(1)-104(2) and a plurality of speakers 106(1)-106(2) by a multi-wire bus 108. While only two microphones and two speakers are illustrated, it should be appreciated that more may be present. The multi-wire bus 108 includes a clock line 110 and one or more (up to eight) data lines 112(1)-112(8). The application processor 102 is generally regarded as a master or audio bus master of the SOUNDWIRE system 100, and the plurality of microphones 104(1)-104(2) and the plurality of speakers 106(1)-106(2) (as well as any other audio components) are slaves. While illustrated as the application processor 102, it should be appreciated that the application processor 102 could be replaced by a codec (not illustrated) or the like. The multi-wire bus 108 is limited by the SOUNDWIRE specification to less than 50 centimeters (cm). More information on the SOUNDWIRE specification may be found at Specification for SOUNDWIRE, version 1, released on Jan. 21, 2015, available at members.mipi.org/wg/LML/document/folder/8154 to MIPI members. The SOUNDWIRE specification is incorporated by reference in its entirety.

The SOUNDWIRE specification defines a fixed frame having multiple lanes (up to eight). In practice, each lane is assigned to one of the one or more data lines 112(1)-112(8) of the multi-wire bus 108. The frame has rows and columns, In each row, bit slots are provided that may change from any source to any other source.

FIG. 1B has a more detailed, but still simplified, block diagram of the application processor 102. In particular, the application processor 102 may include a bus interface 130 that may include a physical layer (PHY) that is configured to couple to the multi-wire bus 108. The bus interface 130 may also be referred to as a means to couple to an audio bus. While not specifically illustrated, it should be appreciated that the bus interface 130 may include necessary and sufficient circuitry to send and receive signals on the multi-wire bus 108. Such circuitry may be referred to as a transmitter and receiver. The bus interface 130 is controlled by a control system 132 (labeled “CS” in the drawings) and receives a clock signal 134 from a clock source 136.

In conventional operation, the bus interface 130 remains active to handle commands from the control system 132 as well as periodically interrogate slaves to see if there are any interrupts at the slaves. Such activity causes essentially continuous activity on the multi-wire bus 108, which consumes power. This power consuming bus activity is symbolically illustrated in FIG. 2A. Specifically, in timeline 200, the master has an initial ping 202 where the master is getting any slave interrupts. The master then executes a command 204, followed by a long string of pings 206(1)-206(N). During each ping 202, 206(1)-206(N), the link is active with an active clock and data line. This active link can be maintained for hundreds of milliseconds with no actual data being transferred, which consumes power. Such power consumption reduces battery charge in mobile terminals, and increases the frequency with which the mobile terminal must be recharged.

In contrast, exemplary aspects of the present disclosure allow the multi-wire bus 108 to be stopped or idled such that the pings to query the slaves are suspended, resulting in power savings. As the multi-wire bus 108 may be idle in this fashion for hundreds of milliseconds, the power savings may be substantial.

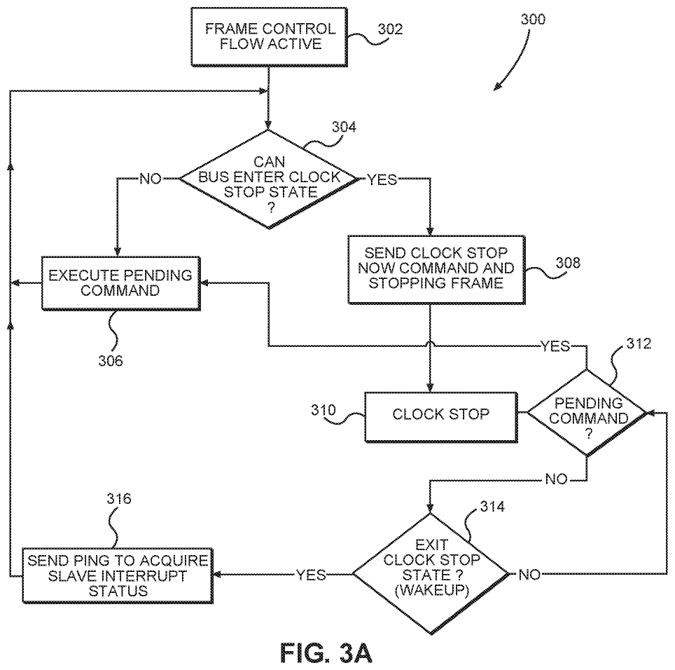

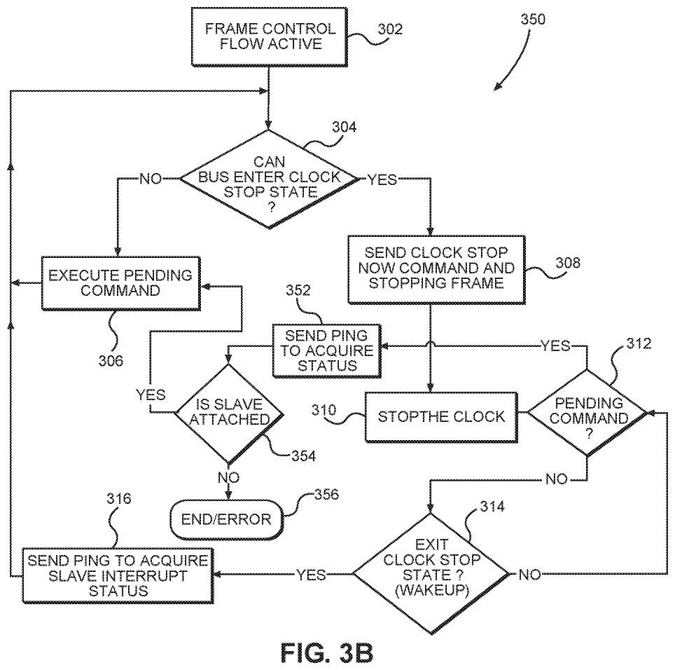

FIG. 2B provides a symbolic illustration of the difference. Specifically, in timeline 220, the master has an initial ping 222 where the master is getting any slave interrupts. Note that the master is active during this ping, and the ping may be sent before execution of any new command. Thus, the master then executes a command 224, followed by a clock stop now command 226 to the slaves, followed by a stopping frame 228. Note that this initial ping may occur after the master exits an idle state as explained below with reference to FIG. 3B.

An exemplary process to allow for link stoppage is provided with reference to FIG. 3A. In particular, a process 300 begins with a frame control flow active (block 302). The master determines if there is a pending command that would preclude entry into a clock stop state (e.g., can the bus enter a clock stop state) (block 304). If there is a pending command (i.e., the answer at block 304 is no), the master executes the pending command (block 306) and returns to block 304. if the answer to block 304 is yes, the multi-wire bus 108 can enter a clock stop state, then the master sends a clock stop now command 226 and a stopping frame 228 (block 308). After the stopping frame, the clock on the multi-wire bus 108 is stopped (i.e., clock stop) (block 310). Note that the clock source 136 may continue to provide a clock signal 134, but the clock signal 134 is not passed to the multi-wire bus 108. Further, it is possible that the clock source 136 may be put into a sleep or low-power state, but such is not required to achieve the power savings discussed herein. The master may monitor for a pending command (block 312), where if there is a pending command, the multi-wire bus 108 exits the clock stop state and returns to block 306 to execute the command. Alternatively, if there is no pending command, the master continues to monitor the multi-wire bus 108 to see if one or more slaves has an interrupt condition by determining if there is a wakeup signal on the multi-wire bus 108 (block 314). The master may then send a ping to acquire a slave interrupt status (block 316) and return to normal operation. Note as illustrated in FIG. 3A, when the master has a pending command at block 312, the command is executed at block 306. In practice, it is more practical to validate that a destination slave is still attached to the bus before execution of the command. Such validation may be done with an initial ping such as ping 222 of FIG. 2B and as also illustrated in a process 350 in FIG. 3B.

The process 350 is substantially similar to process 300 but before the process 350 returns to block 306 for execution of the command, the master sends a ping (e.g., ping 222) to acquire a status of one or more slaves (block 352). This ping determines whether the slave(s) is still attached (block 354). If the answer to block 354 is negative, then the process 350 ends and an error is generated (block 356). The error may occur when the slave does not operate correctly (due to a different system error condition, such as a low batter). The error may be provided to an operating system or the like. Otherwise, the command is executed at block 306.

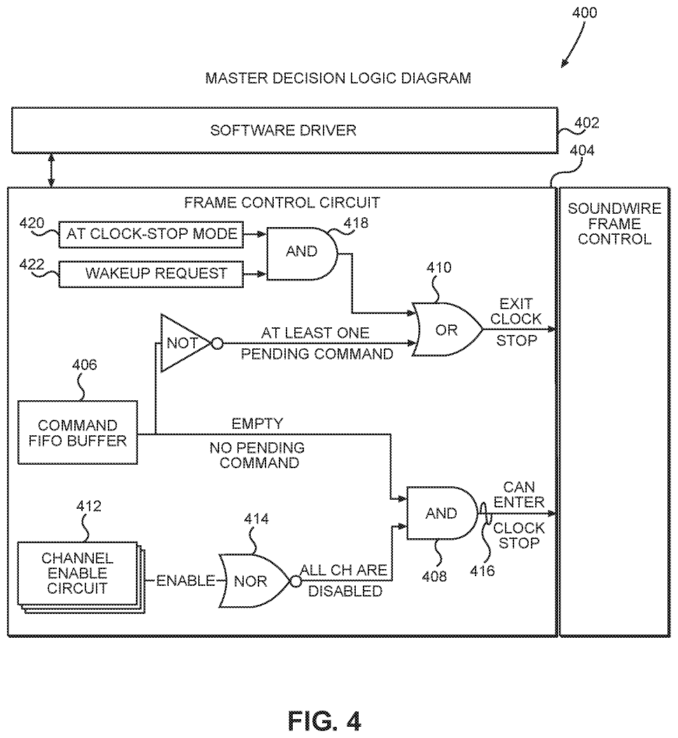

Exemplary aspects of the present disclosure are enabled by a software driver working with a circuit in the bus interface 130. It should be appreciated that after enabling the circuit, the software driver can enter a temporal “sleep” condition, where low-level operations of the bus interface 130 operate without software intervention. One exemplary such circuit 400 is illustrated in FIG. 4. In particular, a software driver 402 issues commands and receives information from a frame control circuit 404. The frame control circuit 404 may also be referred to as means to enter a clock stop state when a command is not pending. The frame control circuit 404 includes a command first in-first out (FIFO) buffer 406 that receives commands from the software driver 402. The output of the command FIFO buffer 406 is provided to an AND gate 408 if the command FIFO buffer 406 is empty and to an OR gate 410 if there is at least one command pending.

The software driver 402 also indicates which data ports are enabled through a channel enable circuit 412. The enable signals are provided to a negative OR (NOR) gate 414. When all port channels are disabled, a signal is provided to the AND gate 408. When both inputs to the AND gate 408 are present, a clock stop enter enable signal 416 is provided.

The OR gate 410 also receives a signal from a second AND gate 418. The second AND gate 418 receives a first input 420 indicating that the multi-wire bus 108 is in a clock stop state and a second input 422 indicating that a wakeup request has been received. Thus, when the multi-wire bus 108 is in a clock stop state and a wakeup request is received, the AND gate 418 outputs a signal to the OR gate 410 to exit the clock stop state. The OR gate 410 also outputs a signal to exit the clock stop state when there is at least one pending command. The circuit 400 thus allows entry into the clock stop state and exit from the clock stop state to provide commands or respond to interrupts.

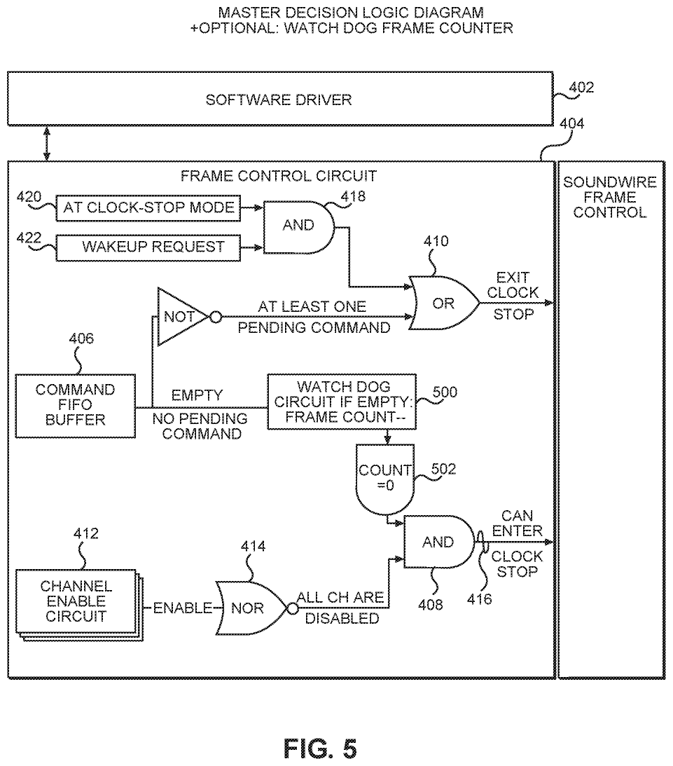

FIG. 5 illustrates a similar circuit, but with a watch dog circuit 500 added that increments a counter 502 before providing a signal to the AND gate 408. This watch dog circuit 500 effectively delays entry into the clock stop state in case there are a series of commands that are spaced temporally by less than a predefined threshold number of frames. For example, the counter 502 may be set at six (6) frames. Commands that are spaced apart by two, three, four, five, and six frames would be received before the watch dog circuit 500 authorizes entry into the clock stop state. Note that the frames are default frames where no new command is sent, only the default ping which tracks the status of the slaves. Each time such a spaced command is received, the counter 502 resets and the watch dog circuit 500 waits to see if another temporally-spaced command is received. In this fashion, quick and repetitive entry into and exit from the clock stop state are avoided and latency may be reduced.

The systems and methods for power conservation on an audio bus through clock manipulation according to aspects disclosed herein may he provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

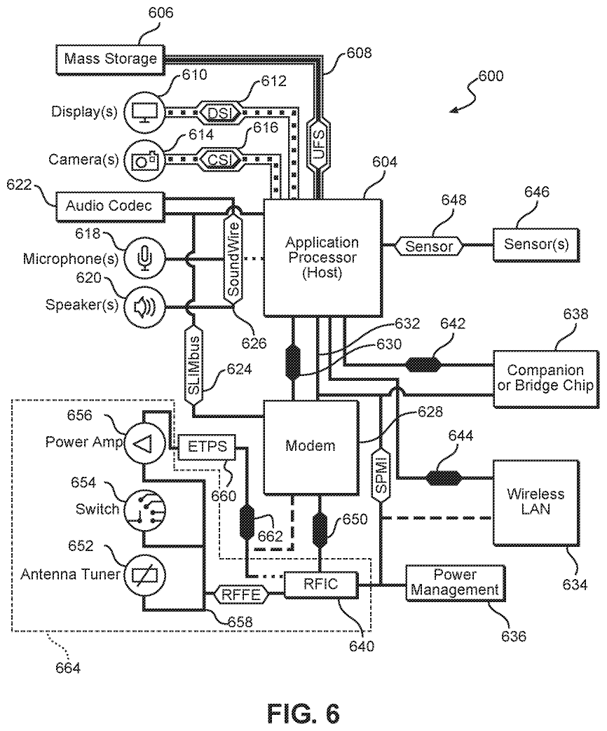

In this regard, FIG. 6 is a system-level block diagram of an exemplary mobile terminal 600 such as a smart phone, mobile computing device tablet, or the like that can include the SOUNDWIRE system 100 of FIG. 1A. While a mobile terminal having a SOUNDWIRE bus is particularly contemplated as being capable of benefiting from exemplary aspects of the present disclosure, it should be appreciated that the present disclosure is not so limited and may be useful in any system having a time division multiplexed (TDM) bus.

With continued reference to FIG. 6, the mobile terminal 600 includes an application processor 604 (sometimes referred to as a host) that communicates with a mass storage element 606 through a universal flash storage (UFS) bus 608. The application processor 604 may further be connected to a display 610 through a display serial interface (DSI) bus 612 and a camera 614 through a camera serial interface (CSI) bus 616. Various audio elements such as a microphone 618, a speaker 620, and an audio codec 622 may he coupled to the application processor 604 through a serial low-power interchip multimedia bus (SLIMbus) 624. Additionally, the audio elements may communicate with each other through a SOUNDWIRE bus 626. Note that the application processor 604 may optionally be connected to the SOUNDWIRE bus 626 (denoted by a dotted line). A modem 628 may also be coupled to the SLIMbus 624 and/or the SOUNDWIRE bus 626. The modem 628 may further be connected to the application processor 604 through a peripheral component interconnect (PCI) or PCI express (PCIe) bus 630 and/or a system power management interface (SPMI) bus 632.

With continued reference to FIG. 6, the SPMI bus 632 may also be coupled to a local area network (LAN or WLAN) IC (LAN IC or WLAN IC) 634, a power management integrated circuit (PMIC) 636, a companion IC (sometimes referred to as a bridge chip) 638, and a radio frequency IC (RFIC) 640. It should be appreciated that separate PCI buses 642 and 644 may also couple the application processor 604 to the companion IC 638 and the WLAN IC 634. The application processor 604 may further be connected to sensors 646 through a sensor bus 648. The modem 628 and the RFIC 640 may communicate using a bus 650.

With continued reference to FIG. 6, the RFIC 640 may couple to one or more RFFE elements, such as an antenna tuner 652, a switch 654, and a power amplifier 656 through a radio frequency front end (RFFE) bus 658. Additionally, the RFIC 640 may couple to an envelope tracking power supply (ETPS) 660 through a bus 662, and the ETPS 660 may communicate with the power amplifier 656. Collectively, the RFFE elements, including the RFIC 640, may be considered an RFFE system 664. It should be appreciated that the RFFE bus 658 may be formed from a clock line and a data line (not illustrated).

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may he combined. It is to he understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, hits, symbols, and chips that may he referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will he readily apparent to those skilled in the art, and the generic principles defined herein may be applied to other variations. Thus, the disclosure is not intended to be limited to the examples and designs described herein, but is to be accorded the widest scope consistent with the principles and features disclosed herein.

What is claimed is:

1. An apparatus comprising an audio bus master, the audio bus master comprising:
a bus interface coupled to an audio bus, the bus interface comprising:
a frame control circuit configured to enter a clock stop state when a command is not pending.

2. The apparatus of claim 1, wherein the audio bus master comprises a SOUNDWIRE audio bus master and the audio bus comprises a SOUNDWIRE audio bus.

3. The apparatus of claim 1, wherein the audio bus master further comprises a clock source configured to provide a clock signal to the frame control circuit.

4. The apparatus of claim 1, wherein the frame control circuit is further configured to detect a wakeup request on the audio bus.

5. The apparatus of claim 4, wherein the audio bus master is configured to exit the clock stop state and initiate a slave interrupt status inquiry responsive to the wakeup request.

6. The apparatus of claim 1, wherein the frame control circuit comprises a watch dog circuit.

7. The apparatus of claim 6, wherein the watch dog circuit comprises a counter and the watch dog circuit is configured to delay entry into the clock stop state.

8. The apparatus of claim 1, wherein the audio bus master is integrated into an integrated circuit (IC).

9. The apparatus of claim 1 comprising a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter, wherein the audio bus master is integrated into the device.

10. The apparatus of claim 1, wherein the frame control circuit is configured to enter the clock stop state automatically when the command is not pending.

11. An apparatus comprising an audio bus master, the audio bus master comprising:
a means to couple to an audio bus, the means to couple to the audio bus comprising:
a means to enter a clock stop state when a command is not pending.

12. The apparatus of claim 11, wherein the means to couple to the audio bus comprises a bus interface comprising a physical layer (PHY).

13. A method of controlling an audio bus, the method comprising:
determining that no command is pending for the audio bus; and
entering a clock stop state responsive to determining that no command is pending.

14. The method of claim 13, wherein determining that no command is pending comprises determining with a frame control circuit.

15. The method of claim 13, wherein entering the clock stop state comprises sending a command to a slave over the audio bus and sending a stopping frame.

16. The method of claim 13, further comprising counting a number of frames with a counter before determining.

17. The method of claim 13, wherein the audio bus comprises a SOUNDWIRE audio bus.

18. The method of claim 13, further comprising detecting a wakeup request while in the clock stop state.

19. The method of claim 18, further comprising, responsive to the wakeup request, interrogating a slave as to a slave interrupt status.
